(19) United States
(12) Patent Application Publication
(10) Pub. No.: US 2026/0050820 A1
(43) Pub. Date: Feb. 19, 2026

(54) SYSTEMS, APPARATUSES, METHODS, AND NON-TRANSITORY COMPUTER-READABLE STORAGE MEDIA EMPLOYING SIMILARITY-BASED FILTERING FOR FOUNDATION MODELS

(71) Applicant: HUAWEI TECHNOLOGIES CO., LTD., Shenzhen (CN)

(72) Inventors: Shaowei WANG, Winnipeg (CA); Ximing Dong, Kingston (CA); Dayi Lin, Toronto (CA); Ahmed E. Hassan, Kingston (CA)

(21) Appl. No.: 18/806,966

(22) Filed: Aug. 16, 2024

(51) Int. Cl. G06N 20/00

(52) U.S. Cl. CPC G06N 20/00

(57) ABSTRACT

A computerized method has the steps of: at a first timestep: obtaining a first candidate token, the first candidate token being generated by a foundation model based on an input; and based on a similarity comparison between the first candidate token and one or more sample tokens, allowing the foundation model to use the first candidate token for generating an output.

### FIELD OF THE DISCLOSURE

The present disclosure relates generally to systems, apparatuses, methods, and computer-readable storage media for foundation models, and in particular to systems, apparatuses, methods, and computer-readable storage media employing similarity-based filtering for foundation models.

### BACKGROUND

Foundation models or language models (LMs) such as large language models (LLMs) are neural network models that may learn the semantics and syntax of language by encoding (sub) words into vector representations. Foundation models have been used in various artificial intelligence (AI) applications such as generative AI systems. However, existing LLMs for generic QA systems have several disadvantages such as high computational cost and they may be slow for user experiences.

### SUMMARY

According to one aspect of this disclosure, there is provided a computerized method at a first timestep: obtaining a first candidate token, the first candidate token being generated by a foundation model based on an input; and based on a similarity comparison between the first candidate token and one or more sample tokens, allowing the foundation model to use the first candidate token for generating an output.

In some embodiments, the foundation model is large language model (LLM).

In some embodiments, the one or more sample tokens represent toxic content, improper content, copyright-infringing content, or a combination thereof.

In some embodiments, the input is a prompt inputted to the foundation model.

In some embodiments, the computerized method further comprises: repeating said obtain and allowing steps for a plurality of timesteps to obtain a plurality of first candidate; and in response to the input, generating the output based on the first candidates that are allowed to use.

In some embodiments, the output is content responsive to the prompt.

In some embodiments, the output is in form of text, image, audio, video, or a combination thereof.

In some embodiments, said based on the similarity comparison between the first candidate token and the one or more sample tokens, allowing the foundation model to use the first candidate token for generating the output comprises: allowing the foundation model to use the first candidate token for generating the output if a similarity between the first candidate token and each of the one or more sample tokens is smaller than a threshold.

In some embodiments, the computerized method further comprises: rejecting the first candidate token if a similarity between the first candidate token and one of the one or more sample tokens is smaller than the threshold.

In some embodiments, the similarity comparison comprises: calculating a cosine similarity between the first candidate token and one of the one or more sample tokens.

In some embodiments, the threshold ThrV is 0≤ThrV≤1.

In some embodiments, the threshold is 0.3.

In some embodiments, the computerized method further comprises: clustering a plurality of sample tokens into one or more clusters using a clustering method; and randomly selecting a subset of R sample tokens from each of the one or more clusters to form the one or more sample tokens.

In some embodiments, the clustering method is a non-parametric clustering method.

In some embodiments, the computerized method further comprises: determining a second timestep for obtaining a second candidate token and for determining whether or not to allow the foundation model to use the second candidate token for generating the output; said determining the second timestep comprising: determining the second timestep based on the similarity comparison between the first candidate token and the one or more sample tokens.

In some embodiments, said determining the second timestep based on the similarity comparison between the first candidate token and the one or more sample tokens comprises: determining the second timestep as:

nextStep=curStep+┌2^{λ(ThrV-min(similarity(C,DE1),similarity(C,DE2), . . . )}┐,

where curStep represents the first timestep, nextStep represents the second timestep, ┌x┐ is the ceiling function that calculates the smallest integer that is greater than or equal to x, λ≥1 is a predefined or predetermined parameter, min(y₁, y₂, . . . ) is the minimum function returning the minimum of its input parameters y₁, y₂, . . . , C represents the first candidate token, DE represents one or more sample tokens, DEi (i=1, 2, . . . ) represents the one or more sample tokens, and the function similarity (C, DEi) (i=1, 2, . . . ) computes the similarity between the first candidate token C and each sample token.

In some embodiments, λ=200.

According to one aspect of this disclosure, there is provided a system comprising: one or more non-transitory, computer-readable storage media; and one or more processors functionally connected to the one or more non-transitory, computer-readable storage media; wherein the one or more non-transitory, computer-readable storage media comprising computer-executable instructions; and wherein the instructions, when executed, cause the one or more processors to perform the above-described method.

According to one aspect of this disclosure, there is provided an apparatus comprising one or more processors functionally connected to one or more memories storing instructions; the one or more processors are configured to execute the instructions to perform the above-described method.

According to one aspect of this disclosure, there is provided one or more memories storing instructions; the instructions, when executed, cause one or more processors to perform the above-described method.

In another aspect, embodiments of this disclosure provide an apparatus, wherein the apparatus comprises a function or unit to perform any of the methods disclosed herein.

In another aspect, embodiments of this disclosure provide a computer readable storage medium, comprising one or more instructions, wherein when the one or more instructions are run on a computer, the computer performs any of the methods disclosed herein.

In another aspect, embodiments of this disclosure provide a non-transitory computer-readable medium storing instruction the instructions causing a processor in a device to implement any of the methods disclosed herein.

In another aspect, embodiments of this disclosure provide a device configured to perform any of the methods disclosed herein.

In another aspect, embodiments of this disclosure provide a processor, configured to execute instructions to cause a device to perform any of the methods disclosed herein.

In another aspect, embodiments of this disclosure provide an integrated circuit configure to perform any of the methods disclosed herein.

According to one aspect of this disclosure, there is provided a module comprising: one or more circuits for performing the above-described method.

According to one aspect of this disclosure, there is provided one or more processors functionally connected to one or more memories for performing the above-described method.

According to one aspect of this disclosure, there is provided an apparatus comprising: one or more processors functionally connected to one or more memories for performing the above-described method.

According to one aspect of this disclosure, there is provided an apparatus configured to perform the above-described method.

In some embodiments the apparatus comprises one or more units configured to perform the above-described method.

According to one aspect of this disclosure, there is provided one or more non-transitory, computer-readable storage media comprising computer-executable instructions, wherein the instructions, when executed, cause at least one processing unit, at least one processor, or at least one circuits to perform the above-described method.

According to one aspect of this disclosure, there is provided one or more computer-readable storage media storing a computer program, wherein, when the computer program is executed by an apparatus, the apparatus is enabled to implement the above-described method.

According to one aspect of this disclosure, there is provided a computer program product including one or more instructions, wherein, when the instructions are executed by an apparatus, the apparatus is enabled to implement the above-described method.

According to one aspect of this disclosure, there is provided a computer program, wherein, when the computer program is executed by a computer, an apparatus is enabled to implement the above-described method.

According to one aspect of this disclosure, there is provided a system comprising a node for performing the above-described method.

According to one aspect of this disclosure, there is provided an apparatus for implementing the method in any possible implementation of the foregoing aspects.

In various embodiments, the methods disclosed herein provide various benefits.

For example, in some embodiments the methods disclosed herein provide a lightweight yet effective framework for foundation models such as LLMs. The methods disclosed herein enhance the token-sampling methods (such as beam search, greedy search, top-k sampling, and/or the like) used in the foundation model by integrating a similarity-based external validator to filter the top candidate tokens (or simply denoted “candidates”) in real-time. One or more candidates that meet certain criteria (such as the invalid candidates that violate the safety constraints) are promptly filtered (such as rejected or processed) during the decoding stage, and other candidate (such as the valid candidates) are proceeded through the search.

In some embodiments, the methods disclosed herein comprises a similarity-based filtering method, which uses a similarity-based validation to validate a candidate based on the similarity between the candidate and a set of one or more demonstration examples (that is, one or more examples that violate safety constraints (such as toxic text)).

For example, the methods disclosed herein assess the similarity between top candidates and the demonstration examples. Candidates exhibiting high similarities to the demonstration examples are promptly filtered, while dissimilar candidates are deemed valid and are processed through the beam search. Thus, the methods disclosed herein disclosed herein offer flexibility for introducing new criteria (such as new safety constraints) by simply providing a certain number of relevant demonstration examples, thereby avoiding the need for training control models.

In various embodiments, demonstration examples may be sourced from user input, existing datasets, generated by LLMs, and/or the like. By validating the top candidates returned by beam search during the decoding state, the methods disclosed herein minimize the impact on the quality of model output, thereby avoiding over-interference and ensuring that the generated text by LLMs have comparable quality as natural output.

In some embodiments, to avoid intervening at each timestep of text generation, the methods disclosed herein use a context-wise timing selection method to select the timing for validation. The context-wise timing selection method measures the similarity between current candidates and demonstration examples, and adjusts the frequency of validation accordingly. For example, more frequent validations are conducted when candidates are similar to demonstration examples, and less frequent validations are conducted otherwise, thereby avoiding over-interference and reducing overhead during inference stage.

### BRIEF DESCRIPTION OF THE DRAWINGS

For a more complete understanding of the disclosure, reference is made to the following description and accompanying drawings, in which:

FIG. 1 is a schematic diagram of a computer network system, according to some embodiments of this disclosure;

FIG. 2 is a schematic diagram showing a simplified hardware structure of a computing device of the computer network system shown in FIG. 1;

FIG. 3 is a schematic diagram showing a simplified software architecture of a computing device of the computer network system shown in FIG. 1;

FIG. 4 is a schematic diagram showing an artificial intelligence (AI) engine, wherein the AI engine comprises a large language model (LLM);

FIGS. 5A to 5C are schematic diagrams showing different types of the LLMs shown in FIG. 4, wherein

FIG. 5A is a schematic diagram showing an encoder-based LLM,

FIG. 5B is a schematic diagram showing a decoder-based LLM, and

FIG. 5C is a schematic diagram showing an encoder-decoder-based LLM;

FIG. 6 is a schematic diagram showing the workflow of a similarity-based filtering method for the LLM shown in FIG. 5B or 5C, according to some embodiments of this disclosure;

FIG. 7 is a schematic diagram showing is the pseudocode showing an example of a similarity-based validation method used in the similarity-based filtering method shown in FIG. 6, according to some embodiments of this disclosure;

FIG. 8A is a plot illustrating the proportion of invalid candidate tokens at each timestep in a detoxification task (that is, safeguarding LLM to prevent it from generating toxic content) using the similarity-based validation method shown in FIG. 7;

FIG. 8B is a boxplot illustrating the similarity between candidate tokens and demonstration examples over each timestep of the detoxification task using the similarity-based validation method shown in FIG. 7;

FIG. 9 is a flowchart showing an example of a procedure for performing the similarity-based filtering method shown in FIG. 6, according to some embodiments of this disclosure; and

FIG. 10 shows an example of pseudocode corresponding to the procedure shown in FIG. 9.

### DETAILED DESCRIPTION

Embodiments disclosed herein relate to systems and apparatuses using large language models (LLMs). The systems and apparatuses disclosed herein may comprise suitable modules and/or circuitries for executing various procedures.

As those skilled in the art understand, a “module” is a term of explanation referring to a hardware structure such as a circuitry implemented using technologies such as electrical and/or optical technologies (and with more specific examples of semiconductors) for performing defined operations or processing. A “module” may alternatively refer to the combination of a hardware structure and a software structure, wherein the hardware structure may be implemented using technologies such as electrical and/or optical technologies (and with more specific examples of semiconductors) in a general manner for performing defined operations or processing according to the software structure in the form of a set of instructions stored in one or more non-transitory, computer-readable storage devices or media.

As will be described in more detail below, a module may be a part of a device, an apparatus, a system, and/or the like, wherein the module may be coupled to or integrated with other parts of the device, apparatus, or system such that the combination thereof forms the device, apparatus, or system. Alternatively, the module may be implemented as a standalone device or apparatus.

The module usually executes a procedure for performing a method. Herein, a procedure has a general meaning equivalent to that of a method. More specifically, a procedure is a defined method implemented using hardware components for processing data. A procedure may comprise or use one or more functions for processing data as designed. Herein, a function is a defined sub-procedure or sub-method for computing, calculating, or otherwise processing input data in a defined manner and generating or otherwise producing output data.

As those skilled in the art will appreciate, a procedure may be implemented as one or more software and/or firmware programs having necessary computer-executable code or instructions and stored in one or more non-transitory computer-readable storage devices or media which may be any volatile and/or non-volatile, non-removable or removable storage devices such as RAM, ROM, EEPROM, solid-state memory devices, hard disks, CDs, DVDs, flash memory devices, and/or the like. A module may read the computer-executable code from the storage devices and execute the computer-executable code to perform the procedure.

Alternatively, a procedure may be implemented as one or more hardware structures having necessary electrical and/or optical components, circuits, logic gates, integrated circuit (IC) chips, and/or the like.

### A. System Structure

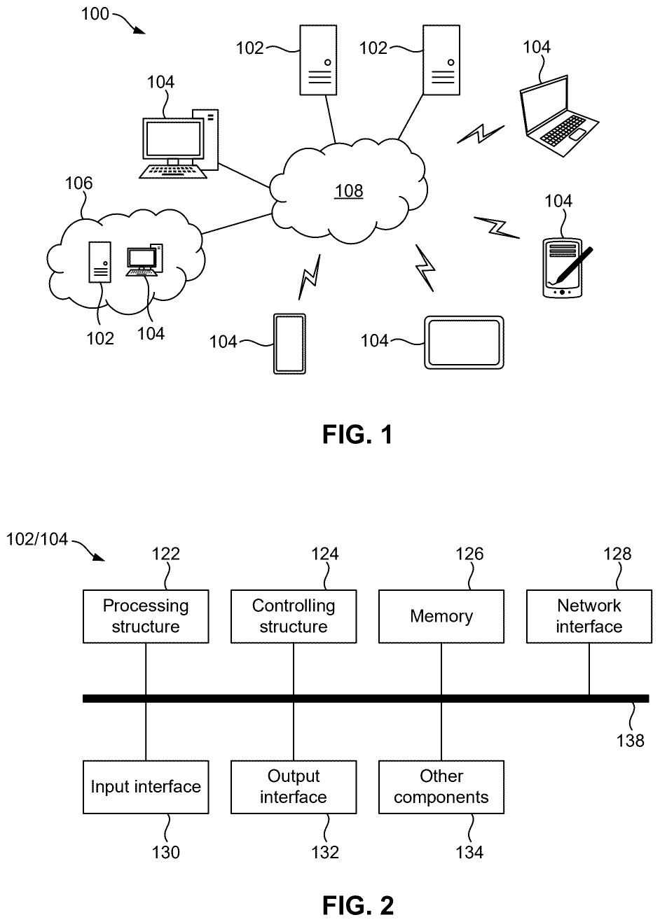

Turning now to FIG. 1, a computer network system is shown and is generally identified using reference numeral 100. As shown, the computer network system 100 comprises one or more server computers 102, a plurality of client computing devices 104, and one or more client computer systems 106 functionally interconnected by a network 108, such as the Internet, a local area network (LAN), a wide area network (WAN), a metropolitan area network (MAN), and/or the like, via suitable wired and wireless networking connections.

The server computers 102 may be computing devices designed specifically for use as a server, and/or general-purpose computing devices acting server computers while also being used by various users. Each server computer 102 may execute one or more server programs.

The client computing devices 104 may be portable and/or non-portable computing devices such as laptop computers, tablets, smartphones, Personal Digital Assistants (PDAs), desktop computers, and/or the like. Each client computing device 104 may execute one or more client application programs which sometimes may be called “apps”.

Generally, the computing devices 102 and 104 comprise similar hardware structures such as hardware structure shown in FIG. 2. As shown, the computing device 102/104 comprises a processing structure 122, a controlling structure 124, one or more non-transitory computer-readable memory or storage devices 126, a network interface 128, an input interface 130, and an output interface 132, functionally interconnected by a system bus 138. The computing device 102/104 may also comprise other components 134 coupled to the system bus 138.

The processing structure 122 may be one or more single-core or multiple-core computing processors, generally referred to as central processing units (CPUs), such as INTEL® microprocessors (INTEL is a registered trademark of Intel Corp., Santa Clara, CA, USA), AMD® microprocessors (AMD is a registered trademark of Advanced Micro Devices Inc., Sunnyvale, CA, USA), ARM® microprocessors (ARM is a registered trademark of Arm Ltd., Cambridge, UK) manufactured by a variety of manufactures such as Qualcomm of San Diego, California, USA, under the ARM® architecture, NVIDIA processor, or the like. When the processing structure 122 comprises a plurality of processors, the processors thereof may collaborate via a specialized circuit such as a specialized bus or via the system bus 138.

The processing structure 122 may also comprise one or more real-time processors, programmable logic controllers (PLCs), microcontroller units (MCUs), u-controllers (UCs), specialized/customized processors, hardware accelerators, and/or controlling circuits (also denoted “controllers”) using, for example, field-programmable gate array (FPGA) or application-specific integrated circuit (ASIC) technologies, and/or the like. In some embodiments, the processing structure includes a CPU (otherwise referred to as a host processor) and a specialized hardware accelerator which includes circuitry configured to perform computations of neural networks such as tensor multiplication, matrix multiplication, and the like. The host processor may offload some computations to the hardware accelerator to perform computation operations of neural network. Examples of a hardware accelerator include a graphics processing unit (GPU), Neural Processing Unit (NPU), and Tensor Process Unit (TPU). In some embodiments, the host processors and the hardware accelerators (such as the GPUs, NPUs, and/or TPUs) may be generally considered processors.

Generally, the processing structure 122 comprises necessary circuitries implemented using technologies such as electrical and/or optical hardware components for executing one or more processes, as the design purpose and/or the use case maybe. For example, the processing structure 122 may comprise logic gates implemented by semiconductors to perform various computations, calculations, and/or processings. Examples of logic gates include AND gate, OR gate, XOR (exclusive OR) gate, and NOT gate, each of which takes one or more inputs and generates or otherwise produces an output therefrom based on the logic implemented therein. For example, a NOT gate receives an input (for example, a high voltage, a state with electrical current, a state with an emitted light, or the like), inverts the input (for example, forming a low voltage, a state with no electrical current, a state with no light, or the like), and output the inverted input as the output.

While the inputs and outputs of the logic gates are generally physical signals and the logics or processing thereof are tangible operations with physical results (for example, outputs of physical signals), the inputs and outputs thereof are generally described using numerals (for example, numerals “0” and “1”) and the operations thereof are generally described as “computing” (which is how the “computer” or “computing device” is named) or “calculation”, or more generally, “processing”, for generating or producing the outputs from the inputs thereof.

Sophisticated combinations of logic gates in the form of a circuitry of logic gates, such as the processing structure 122, may be formed using a plurality of AND, OR, XOR, and/or NOT gates. Such combinations of logic gates may be implemented using individual semiconductors, or more often be implemented as integrated circuits (ICs).

A circuitry of logic gates may be “hard-wired” circuitry which, once designed, may only perform the designed functions. In this example, the processes and functions thereof are “hard-coded” in the circuitry.

With the advance of technologies, it is often that a circuitry of logic gates such as the processing structure 122 may be alternatively designed in a general manner so that it may perform various processes and functions according to a set of “programmed” instructions implemented as firmware and/or software and stored in one or more non-transitory computer-readable storage devices or media. In this example, the circuitry of logic gates such as the processing structure 122 is usually of no use without meaningful firmware and/or software.

Of course, those skilled the art will appreciate that a process or a function (and thus the processor 102) may be implemented using other technologies such as analog technologies.

Referring back to FIG. 2, the controlling structure 124 comprises one or more controlling circuits, such as graphic controllers, input/output chipsets and the like, for coordinating operations of various hardware components and modules of the computing device 102/104.

The memory 126 comprises one or more storage devices or media accessible by the processing structure 122 and the controlling structure 124 for reading and/or storing instructions for the processing structure 122 to execute, and for reading and/or storing data, including input data and data generated by the processing structure 122 and the controlling structure 124. The memory 126 may be volatile and/or non-volatile, non-removable or removable memory such as RAM, ROM, EEPROM, solid-state memory, hard disks, CD, DVD, flash memory, or the like.

The network interface 128 comprises one or more network modules for connecting to other computing devices or networks through the network 108 by using suitable wired or wireless communication technologies such as Ethernet, WI-FI® (WI-FI is a registered trademark of Wi-Fi Alliance, Austin, TX, USA), BLUETOOTH® (BLUETOOTH is a registered trademark of Bluetooth Sig Inc., Kirkland, WA, USA), Bluetooth Low Energy (BLE), Z-Wave, Long Range (LoRa), ZIGBEE® (ZIGBEE is a registered trademark of ZigBee Alliance Corp., San Ramon, CA, USA), wireless broadband communication technologies such as Global System for Mobile Communications (GSM), Code Division Multiple Access (CDMA), Universal Mobile Telecommunications System (UMTS), Worldwide Interoperability for Microwave Access (WiMAX), CDMA2000, Long Term Evolution (LTE), 3GPP, fifth-generation New Radio (5G NR) and/or other 5G networks, fifth-generation (6G) networks, and/or the like. In some embodiments, parallel ports, serial ports, USB connections, optical connections, or the like may also be used for connecting other computing devices or networks although they are usually considered as input/output interfaces for connecting input/output devices.

The input interface 130 comprises one or more input modules for one or more users to input data via, for example, touch-sensitive screen, touch-sensitive whiteboard, touch-pad, keyboards, computer mouse, trackball, microphone, scanners, cameras, and/or the like. The input interface 130 may be a physically integrated part of the computing device 102/104 (for example, the touch-pad of a laptop computer or the touch-sensitive screen of a tablet), or may be a device physically separate from, but functionally coupled to, other components of the computing device 102/104 (for example, a computer mouse). The input interface 130, in some implementation, may be integrated with a display output to form a touch-sensitive screen or touch-sensitive whiteboard.

The output interface 132 comprises one or more output modules for output data to a user. Examples of the output modules comprise displays (such as monitors, LCD displays, LED displays, projectors, and the like), speakers, printers, virtual reality (VR) headsets, augmented reality (AR) goggles, and/or the like. The output interface 132 may be a physically integrated part of the computing device 102/104 (for example, the display of a laptop computer or tablet), or may be a device physically separate from but functionally coupled to other components of the computing device 102/104 (for example, the monitor of a desktop computer).

The computing device 102/104 may also comprise other components 134 such as one or more positioning modules, temperature sensors, barometers, inertial measurement unit (IMU), and/or the like.

The system bus 138 interconnects various components 122 to 134 enabling them to transmit and receive data and control signals to and from each other.

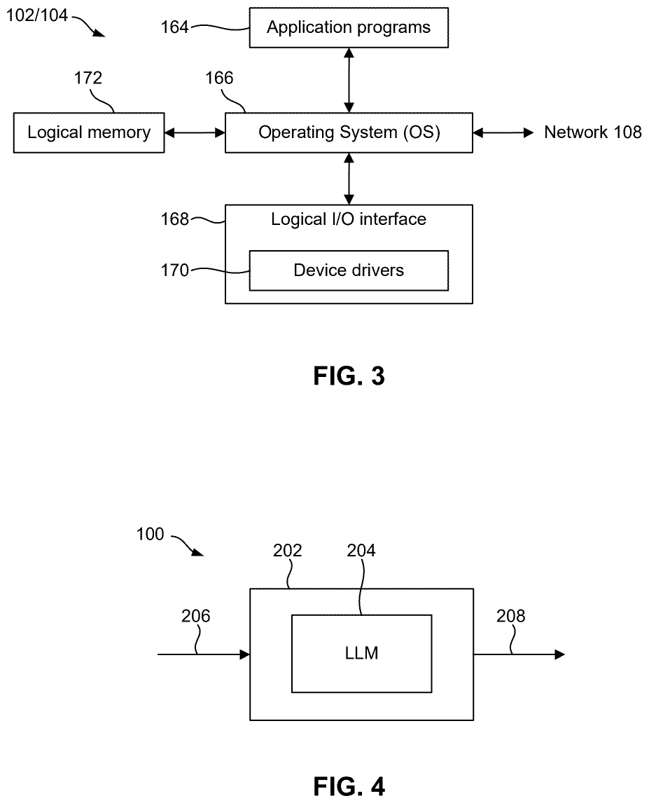

FIG. 3 shows a simplified software architecture of the computing device 102 or 104. On the software side, the computing device 102 or 104 comprises one or more application programs 164, an operating system 166, a logical input/output (I/O) interface 168, and a logical memory 172. The one or more application programs 164, operating system 166, and logical I/O interface 168 are generally implemented as computer-executable instructions or code in the form of software programs or firmware programs stored in the logical memory 172 which may be executed by the processing structure 122.

The one or more application programs 164 executed by or run by the processing structure 122 for performing various tasks.

The operating system 166 manages various hardware components of the computing device 102 or 104 via the logical I/O interface 168, manages the logical memory 172, and manages and supports the application programs 164. The operating system 166 is also in communication with other computing devices (not shown) via the network 108 to allow application programs 164 to communicate with those running on other computing devices. As those skilled in the art will appreciate, the operating system 166 may be any suitable operating system such as MICROSOFT® WINDOWS® (MICROSOFT and WINDOWS are registered trademarks of the Microsoft Corp., Redmond, WA, USA), APPLE® OS X, APPLE® iOS (APPLE is a registered trademark of Apple Inc., Cupertino, CA, USA), Linux, ANDROID® (ANDROID is a registered trademark of Google LLC, Mountain View, CA, USA), or the like. The computing devices 102 and 104 may all have the same operating system, or may have different operating systems.

The logical I/O interface 168 comprises one or more device drivers 170 for communicating with respective input and output interfaces 130 and 132 for receiving data therefrom and sending data thereto. Received data may be sent to the one or more application programs 164 for being processed by one or more application programs 164. Data generated by the application programs 164 may be sent to the logical I/O interface 168 for outputting to various output devices (via the output interface 132).

The logical memory 172 is a logical mapping of the physical memory 126 for facilitating the application programs 164 to access. In this embodiment, the logical memory 172 comprises a storage memory area that may be mapped to a non-volatile physical memory such as hard disks, solid-state disks, flash drives, and the like, generally for long-term data storage therein. The logical memory 172 also comprises a working memory area that is generally mapped to high-speed, and in some implementations volatile, physical memory such as RAM, generally for application programs 164 to temporarily store data during program execution. For example, an application program 164 may load data from the storage memory area into the working memory area, and may store data generated during its execution into the working memory area. The application program 164 may also store some data into the storage memory area as required or in response to a user's command.

In a server computer 102, the one or more application programs 164 generally provide server functions for managing network communication with client computing devices 104 and facilitating collaboration between the server computer 102 and the client computing devices 104. Herein, the term “server” may refer to a server computer 102 from a hardware point of view or a logical server from a software point of view, depending on the context.

As described above, the processing structure 122 is usually of no use without meaningful firmware and/or software. Similarly, while a computer system such as the computer network system 100 may have the potential to perform various tasks, it cannot perform any tasks and is of no use without meaningful firmware and/or software. As will be described in more detail later, the computer network system 100 described herein and the modules, circuitries, and components thereof, as a combination of hardware and software, generally produces tangible results tied to the physical world, wherein the tangible results such as those described herein may lead to improvements to the computer devices and systems themselves, the modules, circuitries, and components thereof, and/or the like.

### B. Foundation Models

In some embodiments, the computer network system 100 executes an artificial intelligence (AI) engine (for example, in the form of one or more software programs). As shown in FIG. 4, the AI engine 202 comprises a foundation model (such as a LLM 204, which is used as an example in the following description) for processing input 206 (also called “prompt”; for example, natural language input in the form of text, voice, images, and/or the like), recognizing and interpreting the input 206 for generating the output 208 in suitable forms (for example, in form of text, image, audio, video, and/or the like) as the response to the prompt 206. As those skilled in the art will appreciate, foundation models such as LLMs are neural network models that learn the semantics and syntax of language by encoding (sub) words into vector representations.

Using LLMs as an example, LLMs use transformer models and are trained using massive datasets. Current LLMs such as Chat-GPT, GPT-4, LLAMA, and PaLM2 have proven to achieve state-of-the-art (SOTA) performance in various natural language processing (NLP) tasks.

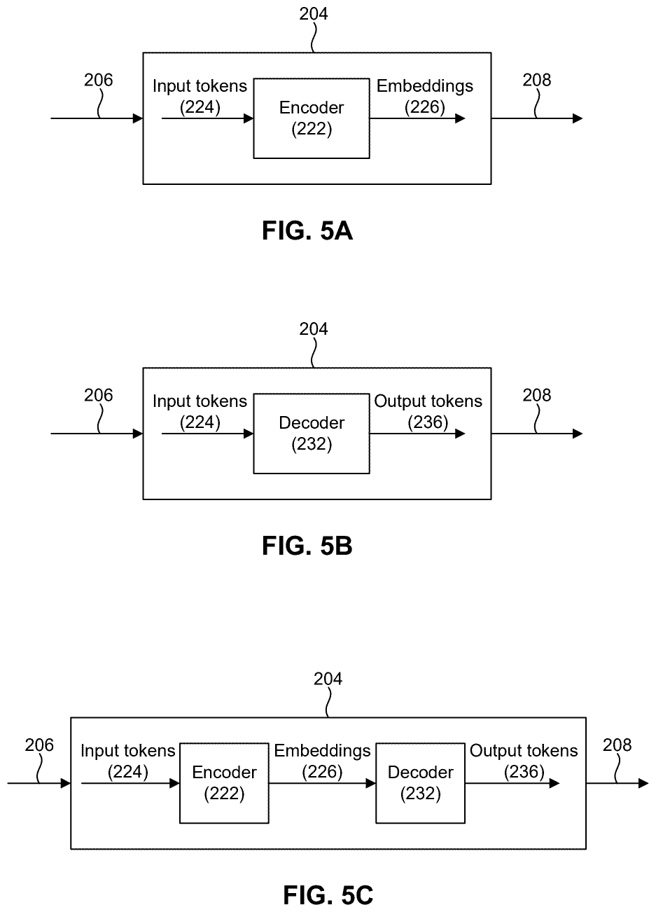

FIGS. 5A to 5C are schematic diagrams showing different types of LLM 204. These figures are simplified diagrams for showing the different types of LLM 204 only, and those skilled in the art will understand that the LLM 204 may also comprise other functional modules that are not shown in these figures.

FIG. 5A shows an encoder-based LLM 204 comprising an encoder 222 which processes the input tokens 224 (which are the units (for example, words or characters partitioned from the prompt 206) and generates embeddings 226 (which are then used to generate the output 208). As those skilled in the art understand, embeddings are high-dimensional vectors encoding semantic contexts and relationships of data tokens.

Most popular LLMs 204 are decoder-based (or “decoder-only”) models. As shown in FIG. 5B, the LLM 204 may be a LLM comprising a decoder 232 which processes the input tokens 224 and generates output tokens 236 (which are then used to generate the output 208). More specifically, the decoder-only LLM 204 learns to produce a distribution for the next token in a sequence given past context as input. Given a prompt sequence of tokens, cₜ={x₁, x₂, . . . , xₜ} where xᵢ ∈ν and ν is a vocabulary of tokens, a distribution p(Xₜ₊₁|cₜ) may be produced for the next token in the sequence during the decoding stage following equations below:

$${logit}_{t} = {f}_{θ} ( {c}_{t} ) , \qquad ( 1 )$$

$$p ( {X}_{t + 1} \vert {c}_{t} ) = softmax ( logit ) , \qquad ( 2 )$$

where logitₜ is the logit vector given by a LLM f_{θ}.

There are two common methods to generate a continuation of the prompt cₜ during the decoding.
Greedy. Tokens are generated by iteratively choosing the most likely token from p(Xₜ₊₁|cₜ), and updating the prompt as cₜ.
Beam Search. In this approach, a set of 2K most likely candidates is maintained at each timestep before pruning back down to K at the last step. For a given candidate at timestep t, bₜ={b₁, b₂, . . . , bₜ}, the likelihood l is computed as:

$$l ( {b}_{t} ) = {\sum }_{j \leq t} log p ( {b}_{j} \vert {b}_{< j} ) \qquad ( 3 )$$

In some embodiments as described in more detail below, the beam search process is modified to prevent the output that violates safety constraints during the decoding stage.

As shown in FIG. 5C, the LLM 204 may be an encoder-decoder-based LLM comprising an encoder 222 which processes the input tokens 224 and generates embeddings 226, and a decoder 232 which generates output tokens 236 based on the embeddings 226 (which are then used to generate the output 208).

LLMs have significantly improved the state-of-the-art on various NLP tasks. These models, powered by advanced techniques such as the generative pre-trained transformer (GPT) architecture, can learn the distribution of their training set well enough to generate realistic text. However, LLMs have also been observed to exhibit hard-to-predict harmful capabilities (for example, generating toxic text), which may lead to ethical and/or societal dangers. Therefore, there is a critical need to safeguard the generation of LLMs.

In prior art, many approaches have been proposed or used to safeguard the LLMs to prevent them from generating content that violates safety constraints, such as toxicity and copyright infringement. These approaches can generally be classified into three main families.

The first family of safeguarding approaches focuses on safeguarding the input of LLM, that is, the prompt. The approaches of this family typically apply a safety net on the input of LLMs to detect and filter out prompts that violate safety constraints. For example, Llama Guard, developed by Meta AI of Astor Place, New York City, New York, U.S.A., provides a framework to safeguard the input of LLMs uses a classifier to detect unsafe prompts (such as violence and sexual content). Similar approaches have also been developed for detecting unsafe prompts.

The second family of safeguarding approaches directly fine-tunes the existing models to optimize the model towards generating content that follows safety constraints. For instance, a prior-art method trained a 1.63 billion-parameter conditional LLM from scratch with constraints to guide generation. Another prior-art approach fine-tunes GPT-2 (that is, Generative Pre-trained Transformer 2, which is an LLM developed by OpenAI of San Francisco, California, U.S.A.) using reinforcement learning to guide GPT-2 to generate safe content (for example, non-toxicity and specific topic). Yet another approach uses prefix-tuning to tune only a small set of parameters of the model to guide text generation towards a specific direction.

The third family of safeguarding approaches focuses on safeguarding the text generation of LLMs in a real-time manner. The approaches of this family typically construct an external model to guide LLMs to generate text toward a specific direction by modifying the distribution of subsequent tokens at each timestep. Suppose LLM generates a distribution of next token Xₜ₊₁ given a prompt P as p(Xₜ₊₁|P). To guide the text generation toward a specific direction, a distribution p(a|Xₜ₊₁) will be computed by the external model, where a is the constraint, and Xₜ₊₁ is the next token. p(a|Xₜ₊₁) provides the probability of the constraint a conditions on Xₜ₊₁.

Following Equation (1), the modified distribution of next token condition on constraint a is then calculated as p(Xₜ₊₁|cₜ, a)∝p(Xₜ₊₁|cₜ)⊕p(a|Xₜ₊₁), where ⊕ indicates a specific operation between p(Xₜ₊₁|cₜ) and p(a|Xₜ₊₁). For example, a widely used operation is to multiply them. Therefore, the approaches of this family generally build an effective external model (discriminator) to estimate p(a|Xₜ₊₁). For instance, FUDGE learns a binary predictor for predicting whether a constraint will become true in the complete future, based on an incomplete sequence prefix (P). Similarly, CriticControl learns a critic network as the discriminator using Actor-Critic reinforcement learning framework. GeDi and DExperts train both conditional classifier and anti-conditional classifier to provide the probabilities p(a|Xₜ₊₁) and p(¬a|Xₜ₊₁). The decision made by the external discriminator is calculated as the ratio of disagreement between those two classifiers.

One of the limitations of the prior-art approaches in the first family is that the safeguard is performed after the generation is done. If unsafe content is detected, the prior-art approaches need to re-generate the content again, which significantly delays the response.

One of the limitations of the prior-art approaches in the second family is that they require to fine-tune the model or training model from scratch, which is very computational expensive and infeasible if the model is very big.

The prior-art approaches in the real-time, third family of safeguarding approaches exhibit at least the following limitations:
Limitation 1: A specific control model has to be trained for defined safety constraints. For instance, to prevent LLMs from generating certain sensitive topics (e.g., gender-biased content), specific control models need to be trained to determine whether a selected subsequent token would lead to the sensitive topics. In addition, prior approaches exhibit a close coupling between the original LLMs and the control model; that is, the control model must be trained in conjunction with the existing LLMs. The limitation leads to inflexibility and computational expense when new safety constraints are added.
Limitation 2: The prior-art approaches proactively intervene at each subsequent token by selecting the tokens to avoid for violating the safety constraints, which may be largely different from the top tokens the model is supposed to output, thereby adversely impacting the quality of text generated by LLMs, as evidenced by significantly higher average Perplexity (abbreviated to PPL, a metric measuring the linguistic quality of language model's output, with a large value indicating low linguistic quality) of 28.96 and 69.30 for the text generated by GPT-2 after applying the SOTA approaches GeDi and CriticControl, compared to naturally produced output by the same model (PPL is 5.6).
Limitation 3: Interfering with the LLM at each step of text generation incurs additional overhead and computational expense. For instance, the previous SOTA approach GeDi requires 0.98 seconds to produce a sequence of 50 tokens on average, which is eight times slower than generation without interference (0.12 seconds) on GPT-2-medium.

In the following, various embodiments of similarity-based filtering methods are described, which may be used for guiding the LLM 204 to generate output that meets certain criteria such as to meet the safety constraints. In other words, given a LLM L, a prompt P={x1, x2, . . . , xt}, where tis the length of prompt, and certain criteria (such as safety constraints, which will be used as an example in the following description) SC={c1, c2, . . . , cn}, where n is the number of safety constraints, the similarity-based filtering methods disclosed herein guides LLM 204 to generate a response (such as a text response) to the prompt that meet the criteria SC. In these embodiments, the safety constraints comprise suitable criteria for identifying toxic content, improper content, copyright-infringing content, and/or the like.

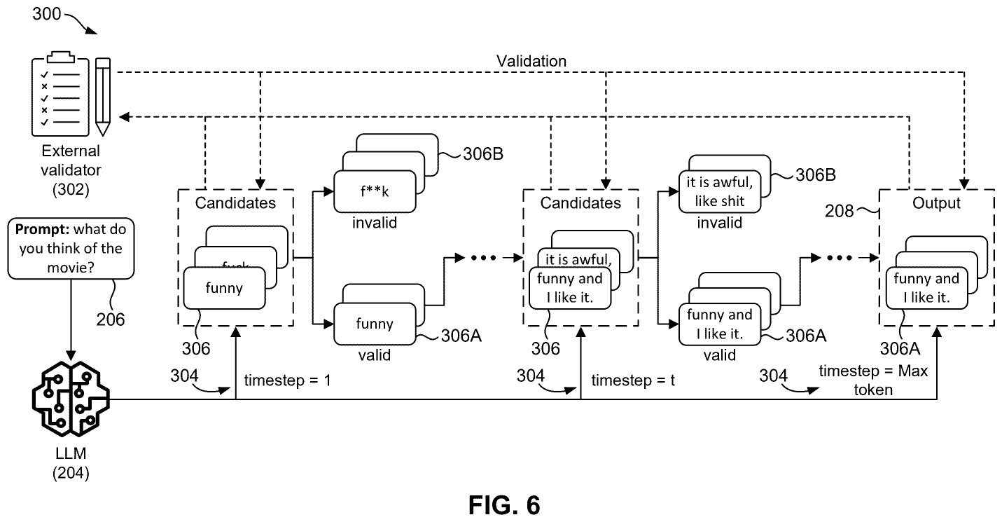

FIG. 6 is a schematic diagram showing the workflow of the similarity-based filtering method 300, according to some embodiments of this disclosure. In these embodiments, the similarity-based filtering method 300 may be implemented as an external validator 302 for the LLM 204, that is, as a separate service, such as in the form of a plugin, for the LLM 204. Herein, the term “separate” means that the service, plugin, software program, or software program module is individually or otherwise independently coded and/or compiled (that is, not an integrated part of the LLM 204), and may be individually or otherwise independently executed by one or more processors with its own memory/storage allocation, threads, and/or the like. Of course, the term “separate” does not mean that the service, plugin, software program, or software program module is isolated from the LLM 204. Instead, the service, plugin, software program, or software program module uses a suitable mechanism (such as a suitable application programming interface (API)) for communicating with the LLM 204 and collaborating with the LLM 204 to generate a response to the prompt that meet the criteria SC.

As shown in FIG. 6, a user (not shown) may enter a prompt 206 such as “what do you think of the movie?” to the LLM 04, wherein the prompt 206 is partitioned into a plurality of input tokens.

In these embodiments, the LLM 204 is a decoder-based LLM or an encoder-decoder-based LLM which generates output tokens based on the input tokens (see FIG. 5B or 5C, respectively) using, for example, beam search. At each timestep 304, the LLM generates one or more candidate output-tokens 306 (simply denoted “candidates”) such as “funny” and “f**k” at the first timestep in FIG. 6, and “funny and I like it.” and “it is awful, like shit” at the t-th timestep. The one or more candidate output-tokens 306 are validated by the similarity-based external validator 302 against predefined or preconfigured safety constraints. Valid candidates 306A (that is, candidates 306A that meet the safety constraints; such as “funny” at the first timestep and “funny and I like it.” at the t-th timestep) are retained or kept for the subsequent timestep. In these embodiments, invalid candidates 306B (that is, candidates 306A that violate the safety constraints; such as “f**k” at the first timestep and “it is awful, like shit” at the t-th timestep) are rejected. When, for example, a predefined or preconfigured terminating condition is met (such as when reaching a predefined or preconfigured maximum number of timesteps, when a predefined or preconfigured maximum number of tokens have been validated, or when a stop signal (such as a stop token) is detected), the retained candidates 306A are used for generating the output response 208 for the prompt 206.

In some embodiments, the similarity-based filtering method 300 validates the candidates 306 using a lightweight yet effective similarity-based approach. More specifically, the similarity-based filtering method 300 compares each candidate with a set of one or more demonstration examples (DEs) that violate the safety constraints, and calculates, or more generally determines, a similarity between the candidate and the set of one or more DEs. A candidate that is similar to the set of one or more DEs (for example, if the candidate's similarity is greater than a predefined or predetermined threshold) is considered an invalid candidate 306B.

In various embodiments, the set of one or more DEs may be obtained from various suitable sources and/or using various suitable methods. For example, in real-world applications, the set of one or more DEs may be obtained from user input, existing datasets, generated by LLMs, and/or the like. Therefore, compared to existing approaches relying on trained discriminators, the similarity-based filtering method 300 is more flexible and lightweight.

In various embodiments, the similarity-based filtering method 300 may use any suitable methods to determine the similarity between a candidate and the set of one or more DEs.

For example, in some embodiments, for each candidate, the similarity-based filtering method 300 calculates the similarity between the candidate and each of the set of one or more DEs; then, the similarity-based filtering method 300 selects the greatest one of these calculated similarities as the similarity between the candidate and the set of one or more DEs. Other selection methods may alternatively be used. For example, the similarity-based filtering method 300 may use the average of these calculated similarities as the similarity between the candidate and the set of one or more DEs. As another example, the similarity-based filtering method 300 may use the average of a subset of these calculated similarities that are greater than a predefined or preconfigured selection threshold as the similarity between the candidate and the set of one or more DEs.

In various embodiments, any suitable method may be used to determine or otherwise calculate the similarity between a candidate and a DE, for example, using string comparison (that is, both the candidate and the DE are considered strings for comparison), value comparison (that is, comparing the suitable values of the candidate and the DE), semantic comparison (that is, comparing the semantic meanings of the candidate and the DE), AI-based similarity comparison (that is, determining the similarity between the candidate and the DE using a suitable AI model such as a suitable LLM), and/or the like.

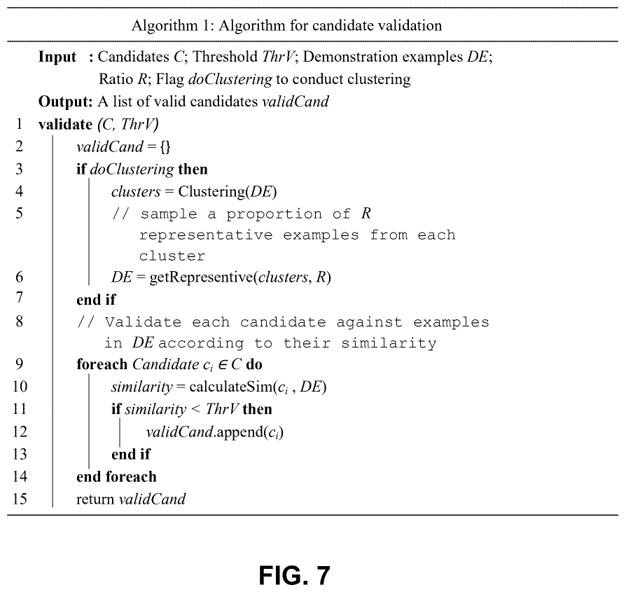

FIG. 7 is the pseudocode showing an example of a similarity-based validation method, according to some embodiments of this disclosure. In this example, the similarity-based validation method takes a plurality of input parameters, including a list of candidates C, a predefined or predetermined threshold ThrV (where 0<ThrV≤1; such as ThrV=0.3), a set of demonstration examples (DE), a ratio R, and Flag doClustering to conduct clustering. In this example, the similarity-based validation method uses a clustering method for data sampling to reduce the size of DE and validates the list of candidates C, and then outputs a list of valid candidates validCand. The clustering of DE is optional. Therefore, the following starts with the description of candidate validation.

For each candidate (cᵢ), the similarity-based validation method computes the similarity between cᵢ and each example in DE (line 10) using cosine similarity. As those skilled in the art understand, cosine similarity measures the similarity between two non-zero vectors (which in this example are cᵢ and each example in DE) defined in an inner product space. In other words, cosine similarity determines whether the two vectors point to approximately the same direction (indicated by the cosine of the angle between the two vectors). Cosine similarity is often used to measure document similarity in text analysis.

If any example in DE exhibits similarity to candidate cᵢ, that is, the similarity there between is greater than the threshold ThrV (line 11), then, cᵢ is invalid. Otherwise, cᵢ is valid and is appended to the valid output validCand (line 12). In this example, Sentence-BERT is employed to embed c; and DE for similarity calculation.

The time complexity of the validation algorithm shown in FIG. 7 is O(|C∥DE|). If the size of the demonstration-example set DE is large, the computation time of the validation algorithm shown in FIG. 7 increases linearly. To mitigate this, while still preserving the effectiveness of our algorithm, this example also uses a clustering method for data sampling to reduce the size of DE while maintaining the diversity of DE.

As shown in lines 3 to 7 in FIG. 7, initially, clustering is performed on all DE (line 4 before DE is updated at line 6). Then, a proportion of R examples are randomly selected from each cluster for forming an updated DE (line 6). In this example, the non-parametric clustering method, Mean Shift, is used. As those skilled in the art understand, the mean-shift clustering method does not require the user to specify the number of clusters in advance. Rather, the mean-shift clustering method iteratively shifts each data point towards the maxima (also called “mode”, that is, the highest density) of the distribution of points within a certain radius until the points converge to a local maximum of the density function.

Of course, in other embodiments, other clustering algorithms may be also or alternatively used. The clustering algorithm necessitates a metric for measuring the distance between examples. Similar to the method shown in FIG. 7, Sentence-BERT is used for embedding and cosine similarity is used for distance measurement. In theory, the effectiveness of the similarity-based validation method is proportional to the size of demonstration examples. Practitioners can determine R based on the context of their application (for example, the trade-off between efficiency and effectiveness).

Compared to existing approaches typically rely on a discriminator (that is, a classification model) that requires training for defined safety constraints (which restricts the flexibility of applying those approaches in real-world LLM applications), the similarity-based validation method is lightweight yet effective in validating the candidates (C).

In some embodiments, the similarity-based filtering method 300 also uses a context-wise timing selection method to validate only when necessary, so as to further increase the efficiency and reduce the computational expenses.

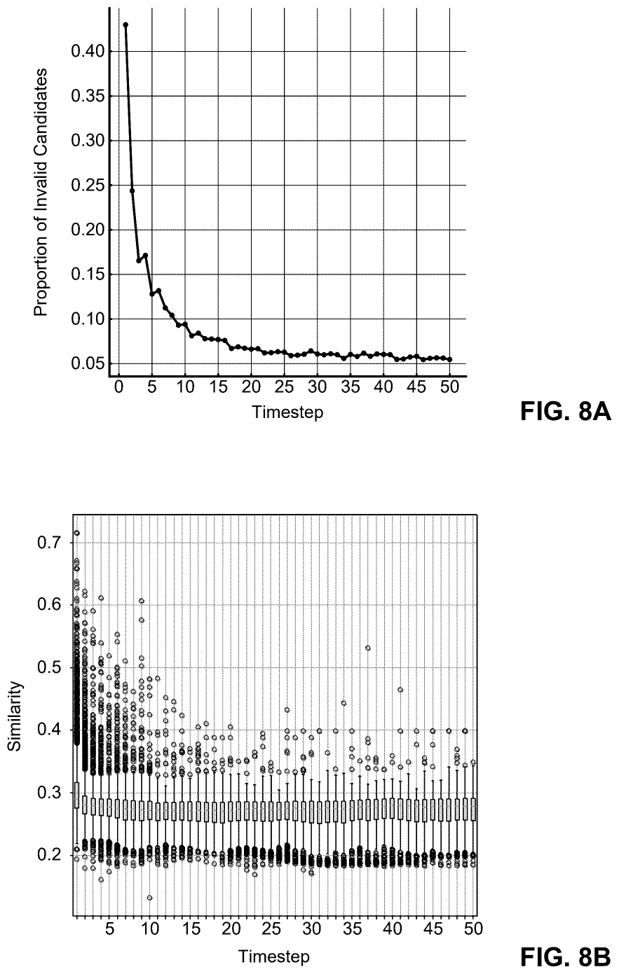

FIG. 8A illustrates the proportion of invalid candidates at each timestep in the detoxification task (that is, safeguarding LLM to prevent it from generating toxic content) using above-described similarity-based validation method (without using the context-wise timing selection method). Notably, FIG. 8A shows a significant decrease in the proportion of invalid candidates, from 0.42 at the initial timestep to 0.05 after 25 timesteps. FIG. 8B shows a similar trend in the similarity between C and DE. Thus, FIGS. 8A and 8B imply that, as the similarity decreases, the likelihood of generating invalid candidates diminishes and the model becomes more likely to generate valid output. Consequently, continuous interference with the LLM at each timestep may be unnecessary, typically, after the initial safeguarding steps when the similarity between C and DE decreases and is low.

Thus, to optimize decoding efficiency and prevent some interference, in some embodiments, the similarity-based filtering method 300 also uses a context-wise timing selection method to select timing for validation based on the context (that is, the similarity between current candidates (C) and the demonstration examples (DE)), and prevents some interference.

More specifically, in these embodiments, the similarity-based filtering method 300 does not validate the candidate C at each timestep. Rather, the similarity-based filtering method 300 uses similarity-based validation method to validate the candidate C based on its similarity to examples in DE, and uses the context-wise timing selection method to determine the frequency of validation. When C closely resembles DE, indicating a higher likelihood of constraint violation, the similarity-based filtering method 300 conducts validation more frequently (that is, using a small timestep-interval between two validation steps, or even at every timestep). Conversely, when C exhibits dissimilarity to DE, the similarity-based filtering method 300 skips a large number of timesteps and validate C less frequently (that is, using a large timestep-interval between two validation steps).

For example, in some embodiments, the context-wise timing selection method uses the following equation to determine the timestep of subsequent validations:

$$nextStep = curStep + ⌈ {2}^{λ ( ThrV - min ( similarity ( C , DE 1 ) , similarity ( C , DE 2 ) , … )} ⌉ , \qquad ( 4 )$$

where curStep represents the current timestep, nextStep represents the timestep for the next validation, ┌x┐ is the ceiling function that calculates the smallest integer that is greater than or equal to x, λ≥1 is a predefined or predetermined parameter (for example, λ=200), min(y₁, y₂, . . . ) is the minimum function returning the minimum of its input parameters y₁, y₂, . . . , and the function similarity (C, DEi) (i=1, 2, . . . ) computes the similarity between the candidate C and each demonstration example DEi in DE.

Given a valid threshold ThrV, if the similarity between C and DE is greater than the threshold ThrV, frequent validation (for example, validation at every timestep according to Equation (4)) is conducted. The parameter λ governs the intensity of control; a higher λ allows for more steps to be skipped (that is, less frequent validation), thereby having less control over the LLM output compared to a smaller λ.

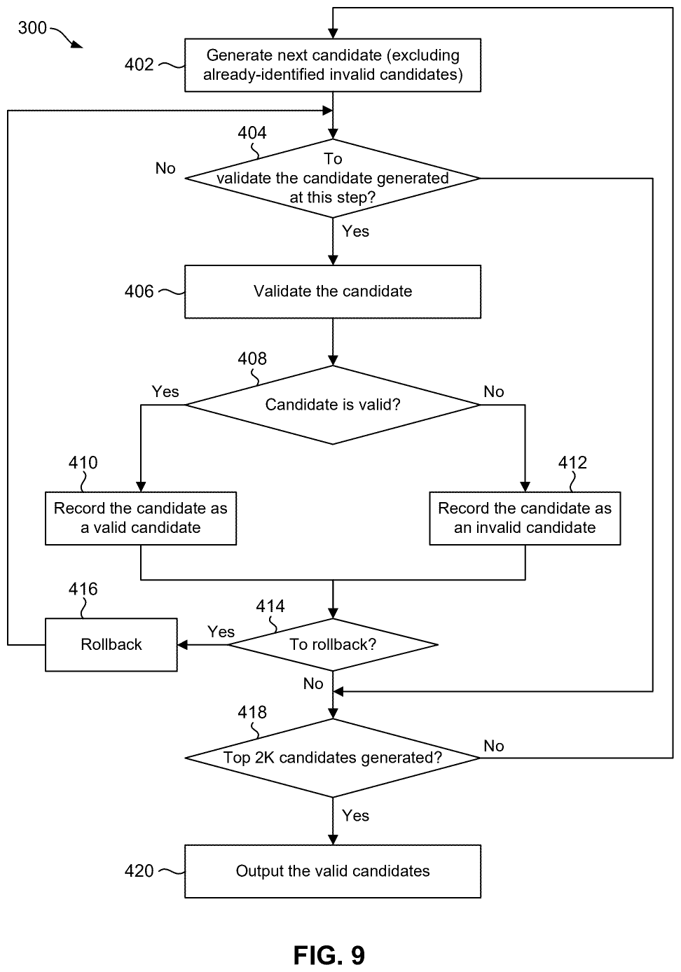

FIG. 9 is a flowchart showing an example of a procedure for performing the similarity-based filtering method 300, according to some embodiments of this disclosure. In these embodiments, the similarity-based filtering method 300 is used in the beam search process for filtering the candidates generated by the beam search process. More specifically, in this example, the similarity-based filtering method 300 is used for filtering the candidates generated by the beam search process generates 2K top candidates, and the similarity-based filtering method 300 is used for filtering these 2K candidates.

At step 402, the beam search process generates a candidate. To prevent redundant invalid candidates, invalid candidates that have been identified in previous validation are excluded or skipped.

At step 404, the similarity-based filtering method 300 determines if the candidate generated at step 402 needs to be validated, by using, for example, the above-described the context-wise timing selection method. If the candidate generated at step 402 does not need to be validated, the procedure goes to step 416 (described later).

If, at step 404, it is determined that the candidate generated at step 402 needs to be validated, the above-described method is then used to validate the candidate (step 406). Based on the validation result, the candidate is recorded as a valid candidate (step 410) or an invalid candidate (step 412).

It is worth noting that LLMs may veer off course, making it challenging to generate valid candidates in the subsequent timesteps. To mitigate this, the similarity-based filtering method 300 uses a rollback mechanism at step 414 to revert to the previous validating timestep to regenerate the candidates and re-validate the candidates regenerated at that timestep, when a predefined or preconfigured condition is triggered. For example, the similarity-based filtering method 300 measures the proportion of invalid candidates against the total number of candidates generated. If this proportion exceeds a predefined or preconfigured threshold ThrRB, a rollback occurs (step 416) and the procedure goes back to step 404 to re-validate the candidate.

If, at step 414, it is determined that no rollback is need, the similarity-based filtering method 300 checks if the top 2K candidates have been generated. If not, the procedure goes back to step 402 to generate the next candidate; if the top 2K candidates have been generated, the similarity-based filtering method 300 outputs the valid candidates (step 420).

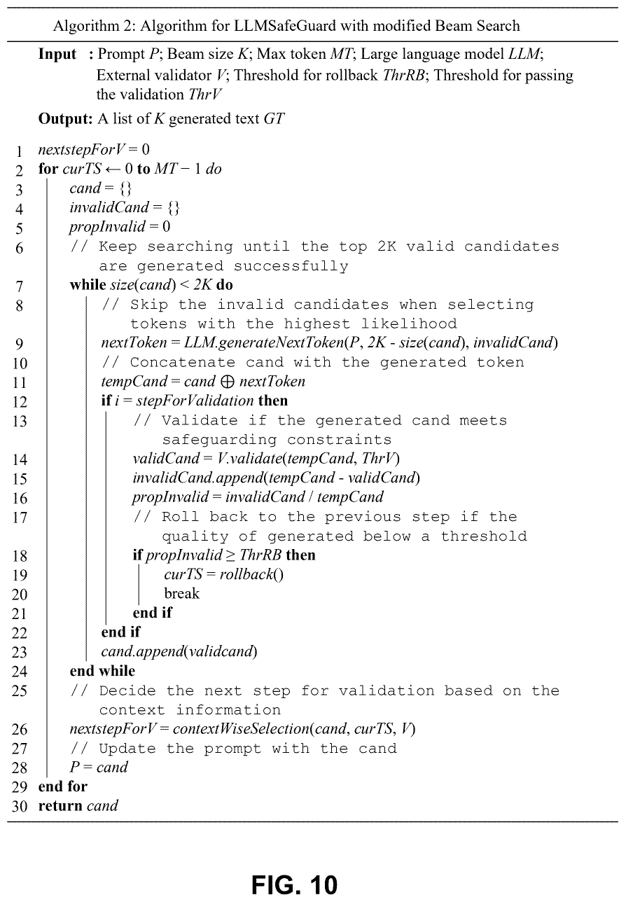

FIG. 10 is an example of pseudocode corresponding to the similarity-based filtering method 300 shown in FIG. 9e. In this example, the similarity-based filtering method 300 takes a plurality of input parameters, including a prompt P, a beam size K, a maximum number of tokens MT, a large language model LLM, an external validator V, a threshold for rollback ThrRB, a threshold for passing the validation ThrV. The similarity-based filtering method 300 outputs a list of K generated text GT.

At each timestep (lines 3-28), the similarity-based filtering method 300 initiates by producing a set of top 2K candidates, where K represents the predefined or preconfigured beam size used for beam search. Within the beam search process, the above-described similarity-based external validator is employed to assess the validity of the generated candidates (line 14).

For instance, in the detoxification task, the similarity-based validator examines whether the candidates exhibit toxicity. If any candidates are deemed invalid, they are rejected, and new most likely candidates are produced until the 2K candidates are filled up (lines 7-24). To prevent redundant invalid candidates, the invalid candidates are skipped in subsequent rounds of candidate generation (line 9). In such a way, the influence of interference on the output quality is minimized as the similarity-based filtering method 300 aims to output top candidates if they are valid.

In this example, the similarity-based filtering method 300 uses the rollback mechanism to revert to the previous validating timestep to regenerate the candidates and re-validate the candidates regenerated at that timestep, when a predefined or preconfigured condition is triggered (lines 17-21). Specifically, the similarity-based filtering method 300 measures the proportion of invalid candidates against the total number of candidates generated. If this proportion exceeds a predefined or preconfigured threshold ThrRB (set to one (1) or 100% in this example), a rollback occurs.

For example, the similarity-based validation method has checked the candidates at timesteps 1, 2, 4, 6, 8, and 10. At timestep 12, the decoder generates 20 candidates. The similarity-based validation method checks these 20 candidates and determines that 10 of these 20 candidates violate the constraint. Thus, the proportion of invalid candidates is 50%. However, in this example, the threshold ThrRB is set to 10%. As the proportion of invalid candidates (50%) is greater than the threshold ThrRB, a rollback occurs and the decoder goes back to the previous timestep 10 to regenerate the candidates.

In another example, the threshold ThrRB is set to one (1) or 100%. Accordingly, the similarity-based filtering method 300 rolls back to the previous timing for validation if all generated candidates are invalid.

As described above, validating the output at each timestep incurs computational costs and may degrade text quality. Therefore, the similarity-based filtering method 300 in this example uses the context-wise timing selection method (line 26) to select the timing of validation, thereby reducing unnecessary interference in the text generation process of LLMs and validation costs.

In above example, the LLM 204 uses beam search with the similarity-based filtering method 300. In some other embodiments, the LLM 204 may use other token-sampling methods such as greedy search, top-k sampling, and/or the like with the similarity-based filtering method 300 in a similar manner, which involves reducing the beam size to one and selecting the valid candidate with the highest likelihood over timesteps.

Herein, a filtering method 300 is disclosed, which provides a lightweight yet effective framework for foundation models such as LLMs. The similarity-based filtering method 300 enhances the token-sampling methods (such as beam search, greedy search, top-sampling, and/or the like) used in the foundation model by integrating a similarity-based external validator to filter the top candidates in real-time. One or more candidates that meet certain criteria (such as the invalid candidates that violate the safety constraints) are promptly filtered (such as rejected or processed) during the decoding stage, and other candidate (such as the valid candidates) are proceeded through the search.

In some embodiments, the filtering method 300 is a similarity-based filtering method, which uses a similarity-based validation to validate a candidate based on the similarity between the candidate and a set of one or more demonstration examples (that is, one or more examples that violate safety constraints (such as toxic text)).

For example, the similarity-based filtering method 300 assesses the similarity between top candidates and the demonstration examples. Candidates exhibiting high similarities to the demonstration examples are promptly filtered, while dissimilar candidates are deemed valid and are processed through the beam search. Thus, the similarity-based filtering method 300 disclosed herein offers flexibility for introducing new criteria (such as new safety constraints) by simply providing a certain number of relevant demonstration examples, thereby avoiding the need for training control models (to address above-described Limitation 1).

In various embodiments, demonstration examples may be sourced from user input, existing datasets, generated by LLMs, and/or the like. By validating the top candidates returned by beam search during the decoding state, the similarity-based filtering method 300 minimizes the impact on the quality of model output (to address above-described Limitation 2).

In some embodiments, to avoid intervening at each timestep of text generation, the similarity-based filtering method 300 uses a context-wise timing selection method to select the timing for validation. The context-wise timing selection method measures the similarity between current candidates and demonstration examples, and adjusts the frequency of validation accordingly. For example, more frequent validations are conducted when candidates are similar to demonstration examples, and less frequent validations are conducted otherwise (to address above-described Limitations 2 and 3).

In various embodiments, the methods disclosed herein may be used in any application using language models or foundation models.

For example, the methods disclosed herein may be used to safeguard the foundation model such as LLM to prevent the foundation model from outputting text that violates predefined or preconfigured safety constraints (for example, toxic content, copyright infringement, and/or the like). In various embodiments, the methods disclosed herein may be implemented as a platform or an individual service.

The methods disclosed herein provide a framework that may be implemented in any programing language, such as Python, Java, and/or the like. More specifically, the external validator may be implemented by any language or framework. For instance, the similarity-based validator may be implemented by vector databases (DBs) such as Chroma, Pinecone, and Qdrant. The context-wise timing selection method may be implemented by any programming language and use, for example, Equation (4) described above.

The methods disclosed herein provide a framework that may be applied on any generative language model. The methods disclosed herein enhance beam search to prevent LLM generating context that violate safety constraints during decoding time. As long as the model has a decoding stage and generate text token by token, the methods disclosed herein may be applied to safeguard the text generation. This flexibility ensures that the methods disclosed herein remain adaptable to evolving research and enable users to apply these methods to suit their specific needs and preferences on different LLMs.

As described above, in some embodiments, the similarity-based filtering method 300 may use the similarity-based validation method and the context-wise timing selection method for filtering the token candidates for generating output tokens. In some embodiments, the similarity-based filtering method 300 may use the similarity-based validation method without the context-wise timing selection method for filtering the token candidates for generating output tokens.

In some embodiments, the context-wise timing selection method may be used with other real-time filtering techniques (such as other real-time safeguarding techniques) that need to manipulate the token distribution in the decoding stage.

In some embodiments, the computer network system 100 may only comprise a single computing device 102 or 104 for performing the methods disclosed herein.

In various embodiments, the methods disclosed herein provide various benefits.

For example, in some embodiments the similarity-based validation method is used, which uses a certain number of provided demonstration examples that violate safety constraints (such as toxic text) as the anchor. Specifically, the similarity-based validation method assesses the similarity between top candidates and the demonstration examples. Candidates exhibiting high similarity to the demonstration examples are promptly rejected, while dissimilar ones are deemed valid and are processed through the beam search. Thus, the similarity-based validation method offers flexibility for introducing new safety constraints by simply providing a certain number of demonstration examples, thereby avoiding the need for training control models.

In some embodiments, by validating the top candidates returned by beam search during the decoding state, the methods disclosed herein minimizes the impact on the quality of model output, thereby avoiding over-interference and ensuring that the generated text by LLMs have comparable quality as natural output.

In some embodiments, the context-wise timing selection method is used to select the timing for validation based on context, thereby avoiding over-interference and reducing overhead during inference stage.

Herein, use of language such as “at least one of X, Y, and Z,” “at least one of X, Y, or Z,” “at least one or more of X, Y, and Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

In some embodiments, the methods disclosed herein may be implemented as computer-executable instructions stored in one or more non-transitory computer-readable storage devices (in the form of software, firmware, or a combination thereof) such that, the instructions, when executed, may cause one or more physical components such as one or more circuits to perform the methods disclosed herein.

For example, in some embodiments, an apparatus comprising one or more processors functionally connected to one or more non-transitory computer-readable storage devices or media may be used to perform the methods disclosed herein, wherein the one or more non-transitory computer-readable storage devices or media store the computer-executable instructions of the methods disclosed herein, and the one or more processors may read the computer-executable instructions from the one or more non-transitory computer-readable storage devices or media, and executes the instructions to perform the methods disclosed herein.

In some embodiments, an apparatus may not have any processors or computer-readable storage devices or media. Rather, the apparatus may comprise any other suitable physical or virtual (explained below) components for implementing the methods disclosed herein.

In some embodiments, the computer-executable instructions that implement the methods disclosed herein may be one or more computer programs, one or more program products, or a combination thereof.

In some embodiments, the methods disclosed herein may be implemented as one or more circuits, one or more components, one or more units, one or more modules, one or more integrated-circuit (IC) chips, one or more chipsets, one or more devices, one or more apparatuses, one or more systems, and/or the like.

The one or more circuits, one or more components, one or more units, one or more modules, one or more IC chips, one or more chipsets, one or more devices, one or more apparatuses, or one or more systems may be physical, virtual, or a combination thereof. Herein, the term “virtual” (such as a “virtual apparatus”) refers to a circuit, component, unit, module, chipset, device, apparatus, system, or the like that is simulated or emulated or otherwise formed using suitable software or firmware such that it appears as if it is “real” or physical).

The present disclosure encompasses various embodiments, including not only method embodiments, but also other embodiments such as apparatus embodiments and embodiments related to non-transitory computer readable storage media. Embodiments may incorporate, individually or in combinations, the features disclosed herein.

Although this disclosure refers to illustrative embodiments, this is not intended to be construed in a limiting sense. Various modifications and combinations of the illustrative embodiments, as well as other embodiments of the disclosure, will be apparent to persons skilled in the art upon reference to the description.

Features disclosed herein in the context of any particular embodiments may also or instead be implemented in other embodiments. Method embodiments, for example, may also or instead be implemented in apparatus, system, and/or computer program product embodiments. In addition, although embodiments are described primarily in the context of methods and apparatus, other implementations are also contemplated, as instructions stored on one or more non-transitory computer-readable media, for example. Such media could store programming or instructions to perform any of various methods consistent with the present disclosure.

Those skilled in the art will appreciate that the above-described embodiments and/or features thereof may be customized, separated, and/or combined as needed or desired. Moreover, although embodiments have been described above with reference to the accompanying drawings, those of skill in the art will appreciate that variations and modifications may be made without departing from the scope thereof as defined by the appended claims.

What is claimed is:

1. A computerized method comprising:
at a first timestep:
obtaining a first candidate token, the first candidate token being generated by a foundation model based on an input; and
based on a similarity comparison between the first candidate token and one or more sample tokens, allowing the foundation model to use the first candidate token for generating an output.

2. The computerized method of claim 1, wherein said based on the similarity comparison between the first candidate token and the one or more sample tokens, allowing the foundation model to use the first candidate token for generating the output comprises:
allowing the foundation model to use the first candidate token for generating the output if a similarity between the first candidate token and each of the one or more sample tokens is smaller than a threshold.

3. The computerized method of claim 2 further comprising:
rejecting the first candidate token if a similarity between the first candidate token and one of the one or more sample tokens is smaller than the threshold.

4. The computerized method of claim 1 further comprising:
clustering a plurality of sample tokens into one or more clusters using a clustering method; and
randomly selecting a subset of R sample tokens from each of the one or more clusters to form the one or more sample tokens.

5. The computerized method of claim 1 further comprising:
determining a second timestep for obtaining a second candidate token and for determining whether or not to allow the foundation model to use the second candidate token for generating the output;
wherein said determining the second timestep comprising:
determining the second timestep based on the similarity comparison between the first candidate token and the one or more sample tokens.

6. The computerized method of claim 5, wherein said determining the second timestep based on the similarity comparison between the first candidate token and the one or more sample tokens comprises:
determining the second timestep as:
$$nextStep = curStep + ⌈ {2}^{λ ( ThrV - min ( similarity ( C , DE 1 ) , similarity ( C , DE 2 ) , … )} ⌉ ,$$
where curStep represents the first timestep, nextStep represents the second timestep, ┌x┐ is the ceiling function that calculates the smallest integer that is greater than or equal to x, λ≥1 is a predefined or predetermined parameter, min(y₁, y₂, . . . ) is the minimum function returning the minimum of its input parameters y₁, y₂, . . . , C represents the first candidate token, DE represents one or more sample tokens, DEi (i=1, 2, . . . ) represents the one or more sample tokens, and the function similarity (C, DEi) (i=1, 2, . . . ) computes the similarity between the first candidate token C and each sample token.

7. A system comprising:
one or more non-transitory, computer-readable storage media; and
one or more processors functionally connected to the one or more non-transitory, computer-readable storage media;
wherein the one or more non-transitory, computer-readable storage media comprising computer-executable instructions; and
wherein the instructions, when executed, cause the one or more processors to perform actions comprising:
at a first timestep:
obtaining a first candidate token, the first candidate token being generated by a foundation model based on an input; and
based on a similarity comparison between the first candidate token and one or more sample tokens, allowing the foundation model to use the first candidate token for generating an output.

8. The system of claim 7 wherein said based on the similarity comparison between the first candidate token and the one or more sample tokens, allowing the foundation model to use the first candidate token for generating the output comprises:
allowing the foundation model to use the first candidate token for generating the output if a similarity between the first candidate token and each of the one or more sample tokens is smaller than a threshold.

9. The system of claim 8, wherein the actions further comprise:
rejecting the first candidate token if a similarity between the first candidate token and one of the one or more sample tokens is smaller than the threshold.

10. The system of claim 9, wherein the similarity comparison comprises:
calculating a cosine similarity between the first candidate token and one of the one or more sample tokens.

11. The system of claim 7, wherein the actions further comprise:
clustering a plurality of sample tokens into one or more clusters using a clustering method; and
randomly selecting a subset of R sample tokens from each of the one or more clusters to form the one or more sample tokens.

12. The system of claim 7, wherein the actions further comprise:
determining a second timestep for obtaining a second candidate token and for determining whether or not to allow the foundation model to use the second candidate token for generating the output;
wherein said determining the second timestep comprising:
determining the second timestep based on the similarity comparison between the first candidate token and the one or more sample tokens.

13. The system of claim 12, wherein said determining the second timestep based on the similarity comparison between the first candidate token and the one or more sample tokens comprises:
determining the second timestep as:
$$nextStep = curStep + ⌈ {2}^{λ ( ThrV - min ( similarity ( C , DE 1 ) , similarity ( C , DE 2 ) , … )} ⌉ ,$$
where curStep represents the first timestep, nextStep represents the second timestep, ┌x┐ is the ceiling function that calculates the smallest integer that is greater than or equal to x, λ≥1 is a predefined or predetermined parameter, min(y₁, y₂, . . . ) is the minimum function returning the minimum of its input parameters y₁, y₂, . . . , C represents the first candidate token, DE represents one or more sample tokens, DEi (i=1, 2, . . . ) represents the one or more sample tokens, and the function similarity (C, DEi) (i=1, 2, . . . ) computes the similarity between the first candidate token C and each sample token.

14. One or more non-transitory, computer-readable storage media comprising computer-executable instructions, wherein the instructions, when executed, cause one or more processors to perform actions comprising:
at a first timestep:
obtaining a first candidate token, the first candidate token being generated by a foundation model based on an input; and
based on a similarity comparison between the first candidate token and one or more sample tokens, allowing the foundation model to use the first candidate token for generating an output.

15. The one or more storage media of claim 14, wherein said based on the similarity comparison between the first candidate token and the one or more sample tokens, allowing the foundation model to use the first candidate token for generating the output comprises:
allowing the foundation model to use the first candidate token for generating the output if a similarity between the first candidate token and each of the one or more sample tokens is smaller than a threshold.

16. The one or more storage media of claim 15, wherein the actions further comprise:
rejecting the first candidate token if a similarity between the first candidate token and one of the one or more sample tokens is smaller than the threshold.

17. The one or more storage media of claim 16, wherein the similarity comparison comprises:
calculating a cosine similarity between the first candidate token and one of the one or more sample tokens.

18. The one or more storage media of claim 14, wherein the actions further comprise:
clustering a plurality of sample tokens into one or more clusters using a clustering method; and
randomly selecting a subset of R sample tokens from each of the one or more clusters to form the one or more sample tokens.

19. The one or more one or more storage media of claim 14, wherein the actions further comprise:
determining a second timestep for obtaining a second candidate token and for determining whether or not to allow the foundation model to use the second candidate token for generating the output;
wherein said determining the second timestep comprising:
determining the second timestep based on the similarity comparison between the first candidate token and the one or more sample tokens.

20. The one or more one or more storage media of claim 19, wherein said determining the second timestep based on the similarity comparison between the first candidate token and the one or more sample tokens comprises:
determining the second timestep as:
$$nextStep = curStep + ⌈ {2}^{λ ( ThrV - min ( similarity ( C , DE 1 ) , similarity ( C , DE 2 ) , … )} ⌉ , \qquad ( 5 )$$
where curStep represents the first timestep, nextStep represents the second timestep, ┌x┐ is the ceiling function that calculates the smallest integer that is greater than or equal to x, λ≥1 is a predefined or predetermined parameter, min(y₁, y₂, . . . ) is the minimum function returning the minimum of its input parameters y₁, y₂, . . . , C represents the first candidate token, DE represents one or more sample tokens, DEi (i=1, 2, . . . ) represents the one or more sample tokens, and the function similarity (C, DEi) (i=1, 2, . . . ) computes the similarity between the first candidate token C and each sample token.
